(19) United States
(12) Patent Application Publication
(10) Pub. No.: US 2005/0030417 A1
(43) Pub. Date: Feb. 10, 2005

(54) Lens cover assembly for a digital camera

(75) Inventor: Pu-Hua Mei, Junghe City (TW)

Correspondence Address: TROXELL LAW OFFICE PLLC, SUITE 1404, 5205 LEESBURG PIKE, FALLS CHURCH, VA, 22041, US

(73) Assignee: Tekom Technologies, Inc.

(21) Appl. No.: 10/635,546

(22) Filed: Aug. 7, 2003

(51) Int. Cl. H04N 5/225; H04N 9/64

(52) U.S. Cl. 348/373; 348/246

(57) ABSTRACT

The present invention provides a lens cover assembly for a digital camera. The digital camera is composed of a body, a lens, and a lens cover. The lens is disposed in one end of the body. The lens cover has a container to place the lens cover over the lens. A light means is disposed in the container of the lens cover. A control system for controlling the light means is disposed in the body. Whereby, users themselves can perform alignments of dead pixels of an image sensor and light sensitization to a digital camera by the light means in the lens cover, without using additional professional equipments.

### REFERENCE CITED

1. U.S. Pat. No.: 5,214,535
2. U.S. Pat. No.: 5,208,700

### FIELD OF THE INVENTION

The present invention relates to a lens cover assembly for a digital camera. More particularly, by that, users themselves can perform alignments of dead pixels of an image sensor and light sensitization to a digital camera by the light means in the lens cover, without using additional professional equipments.

### BACKGROUND OF THE INVENTION

A conventional digital camera (as shown in FIG. 4), includes: a case 5 having a front surface; a lens 51 with a position close to the front surface of the camera; a support means 52 adjacent to the lens; a lens cover 53 disposed in the support means 52, which is able to shift from a close position for covering the lens 51 and an opening position apart from the lens 51 with a certain distance; a lens hood 54 disposed above the support means 52, which is able to shift from a draw back position and a stretch out position. Wherein, at the stretch out position, the lens hood 54 will surround the central axis of the lens 51, and meanwhile, stretch out beyond the front surface of the case 5. The camera is characterized in that, the drive means is used to move the lens cover 53 from the close position to the open position, and at the same time, move the lens hood 54 from the draw back position to the stretch out position. The above structure is so-called typical conventional digital camera and the embedded lens cover.

However, high-lever digital cameras can not use lens cover in an embedded manner. Therefore, a lens cover is disposed over the lens in the high-lever digital camera. But, in manufacturing, high-lever digital cameras must perform alignments in accordance with various characteristics, including dead pixels of an electronic image sensor and light sensitization. Since as time goes by, each characteristic of the electronic image sensor might become weaker, after using for a certain time period, users have to perform the alignment again. Generally, users often return the camera to its home company or service centers to perform the alignment by means of professional equipments. Professionals need to put the high-lever digital camera in a light-controllable light box in the equipment. Consequently, users have to waste a lot of time or money, and even bear the weaker performance of the digital camera. Accordingly, only by the above conventional manner is not enough to meet actual needs.

### SUMMERY OF THE INVENTION

The main objective of the present invention is to allow users themselves to perform alignments of dead pixels of an image sensor and light sensitization to a digital camera by the fight means in the lens cover, without using additional professional equipments.

To achieve the above objective, the present invention provides a lens cover assembly for a digital camera. The digital camera is composed of a body, a lens, and a lens cover. The lens is disposed in one end of the body. The lens cover has a container to place the lens cover over the lens. A light means is disposed in the container of the lens cover. A control system for controlling the light means is disposed in the body. Whereby, users themselves can perform alignments of dead pixels of an image sensor and light sensitization to a digital camera by the light means in the lens cover, without using additional professional equipments.

### BRIEF DESCRIPTI N OF THE DRAWINGS

The present invention will be better understood from the following detailed description of preferred embodiments of the invention, taken in conjunction with the accompanying drawings, in which

FIG. 1 is a diagram showing a separation view of the present invention;

FIG. 2 is a diagram showing a combination view of the present invention;

FIG. 3 is a diagram showing an operation view of the present invention; and

FIG. 4 is a diagram showing a front view of a digital camera in the prior art.

### DESCRIPTION OF THE PREFERRED EMBODIMENTS

The following descriptions of the preferred embodiments are provided to understand the features and the structures of the present invention.

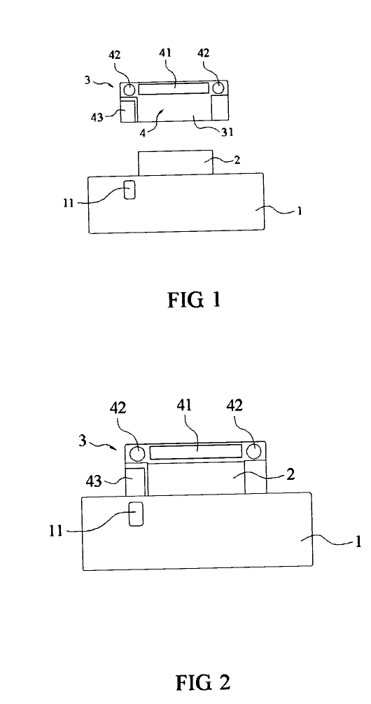

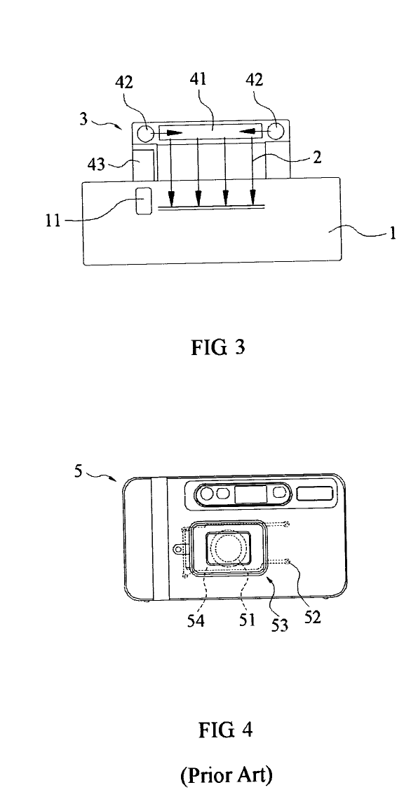

FIG. 1, FIG. 2, and FIG. 3 are a diagram showing a separation view of the present invention, a diagram showing a combination view of the present invention, and a diagram showing an operation view of the present invention. As shown in the diagrams, the present invention provides a lens cover assembly for a digital camera. The digital camera is composed of a body 1, a lens 2, and a lens cover 3 having a fight means 4. By the present invention, users themselves can perform alignments of dead pixels of an image sensor and light sensitization to a digital camera by the light means 4 in the lens cover 3, without using additional professional equipments.

A control system 11 for controlling the light means 4 is disposed in the body 1 mentioned above; the lens 2 is disposed in one end of the body 1.

The lens cover 3 has a container 31 to place the lens cover 3 over the lens 2. A light means 4 is disposed in the container 31 of the lens cover 3. The light means 4 is controlled by the above control system 11, and the light means 4 comprises a light dispersion board 41 disposed on the button of the container 31 of the lens cover 3; a light source 42 in response to the light dispersion board 41 and a receive module 43 connecting to the light source 42. The light source 42 is formed by two luminous bodies respectively disposed at two sides of the light dispersion board 41. The luminous bodies could be light emitting diodes (LED). The control system 11 generates a handshaking signal between the receive module 43 of the light means 4 to control the light means 4 in a wireless manner, or alternatively, generates a handshaking signal between the receive module 43 of the light means 4 to control the light means 4 in a terminal contact manner. Therefore, a novel lens cover assembly as described above is provided.

When performing alignments for a digital camera, users only need to place the lens cover 3 over the lens 2 by the container 31. For the time being, a handshaking signal between the control system 11 and the receive module 43 of the light means 4 will be generated in a wireless manner or in a terminal contact manner. The light dispersion board 41 on the button of the container 31 is in response to the lens 2. Since the body 1 itself is capable of measuring the using frequency or time period, when the body 1 determines that an alignment is required, the right means 4 can access power from the body 1 through the receive module 43 and the control system 11, for supplying the light source 42 of the light means 4. Thus, the light source 42 illuminates and evenly allows fight to emit to the lens 2 of the body 1 through the light dispersion board 41 for helping performing alignments of dead pixels of an image sensor and light sensitization to a digital camera. Whereby, users themselves can perform alignments to a digital camera by the lens cover 3 of the present invention, without using additional professional equipments.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

1. A lens cover assembly for a digital camera, said digital camera composed of a body, a lens, and a lens cover, said lens disposed in one end of said body, said lens cover having a container to place said lens cover over said lens; which is characterized in that:
a light means is disposed in said container of said lens cover; a control system for controlling said light means is disposed in said body.

2. The lens cover assembly of claim 1, wherein said light means comprises a light dispersion board disposed on the button of said container of said lens cover; a light source in response to said light dispersion board and a receive module connecting to said light source.

3. The lens cover assembly of claim 1, wherein said light source is formed by two luminous bodies respectively disposed at two sides of said light dispersion board.

4. The lens cover assembly of claim 1, wherein said luminous bodies are light emitting diodes (LED).

5. The lens cover assembly of claim 1, wherein said control system generates a handshaking signal to control said light means in a wireless manner.

6. The lens cover assembly of claim 1, wherein said control system generates a handshaking signal to control said light means in a terminal contact manner.
